(19) United States
(12) Patent Application Publication
(10) Pub. No.: US 2008/0230243 A1
(43) Pub. Date: Sep. 25, 2008

(54) Disc Tiller Soil Working Machine

(76) Inventor: Michel Evin, Ligne (FR)

Correspondence Address: YOUNG & THOMPSON, 209 Madison Street, Suite 500, ALEXANDRIA, VA, 22314, US

(21) Appl. No.: 10/585,518

(22) PCT Filed: Jan. 17, 2005
(86) PCT No.: PCT/FR2005/000097

§ 371 Date: Sep. 1, 2006

(30) Foreign Application Priority Data
Jan. 19, 2004 (FR) 0400457

(51) Int. Cl. A01B 21/08

(52) U.S. Cl. 172/569

(57) ABSTRACT

A disc tiller soil working machine includes a chassis equipped with tillage implements having at least one front train and one rear train consisting of non-driven rotating discs, each disc or train of discs being independently coupled via a safety device to a support such as a beam shared by the assembly of discs of the train of discs. Each safety device permits the withdrawal of the disc or group of discs. Each disc of a train of discs is, when coupled to its support, rotationally driven about an axis that, together with the longitudinal axis of the support, forms an angle α ranging from 3° to 40°. Each support is mounted on the chassis while being able to pivot about a vertical axis in a manner that permits the opening angle of the assembly of discs of the train of discs to be adjusted within a predetermined angular range.

The present invention relates to a machine for working the soil, of the disc harrow type, comprising a chassis, carried or dragged, provided with plowing tools constituted by at least one forward series and one rear series of non-driven rotatable discs, each disc or groups of discs of a series of discs being, so as to obtain working of the soil to constant depth of the discs, coupled, independently, by means of a safety device, to a support, such as a beam, common to all the discs of the series of discs, each safety device permitting the removal, by lateral and/or vertical escape, of the corresponding disc or group of discs, beyond a predetermined pressure exerted on the disc or group of discs.

Disc harrows, which have appeared in the last ten years in the version mentioned above, are well known today to those skilled in this art.

Soil working machines of the type mentioned above, comprise two series of discs axially offset relative to the direction of advance of the machine. The first series of discs or forward series of the machine permit, because of the design of the discs, projecting a first flow of earth in the course of advance of the machine. This first flow of earth could particularly be used to constitute a seed bed. The second series of discs permit the projection of a second flow of earth which covers the first flow of earth. It is thus possible, thanks to such a disc harrow, to deposit seeds on a bed of ground and bury these grains or seeds to a predetermined depth. The presence of these two flows of earth also permits obtaining a mixture of the earth and preparing the ground properly without turning the soil.

To permit precision operation with such a disc harrow, it is necessary that each disc or group of discs be mounted independently and removably on the chassis of the machine. Thus, when a disc encounters an obstacle, if this disc is mounted independently on the chassis, there results a release of the disc by vertical and/or lateral disengagement without having to raise the rest of the chassis such that the other discs of the chassis can normally operate. As such soil working machines operate at a very high speed of advance, there can be 15 to 20 km/h, the removal of such discs becomes fundamental to avoid breakage or premature wear of the discs. Thus, thanks to such a disc harrow, it is possible to obtain improved working of the soil and at a constant depth. Experiments carried out have also shown that the arrangement of the discs on the chassis, and in particular the presence of an opening angle and generally an intermediate angle, permit optimizing the work on the soil that is to be carried out. Thus, it appears that the possibility of regulating the opening angle of each disc or group of discs permits adapting them to different natures of the ground. Thus, the greater the opening angle, the greater the soil is projected and as a result the greater mixing effect of the soil is obtained with the help of discs. Conversely, when the opening angle is reduced, the discs penetrate better into the ground. As a result, it is necessary, to be able to work with precision, no matter what the nature of the ground, to have an adjustable opening angle which permits acting on the projected quantity of dirt and the depth of penetration of each disc or group of discs into the ground.

Attempts that have been carried out until now to obtain adjustment of the opening angle have not been satisfactory. Thus, because each disc or group of discs must be mounted independently and removably on the support chassis, it is necessary to have, in the region of connection between disc and chassis, a safety device. The conventional design of such a safety device is a spring-loaded oscillating arm. An adjustment of the opening angle of each disc requires being able to couple each disc to its oscillating arm by a pivotable connection permitting pivoting about a vertical axis of the disc to permit adjustment of the opening angle. There results a particularly complicated construction of the connection between the disc and its support which, on the one hand, requires a very great time for adjustment because each disc must be handled independently from the other discs, and on the other hand renders the assembly of the construction inappropriate economically.

Another solution is described in International application WO 2004/004437. In this document, the adjustment of the opening angle of the discs takes place by rotation of the series of discs about a horizontal axis. This design requires having moreover an adjustment device for spacing between discs. As a result, there is a relatively complicated assembly.

There are furthermore known disc harrows, also called crop cover as shown in French patent 2.636.804, U.S. Pat. No. 2,797,452, U.S. Pat. No. 2,041,216 or U.S. Pat. No. 6,158,523. In the case of these machines, the design of the support chassis for the discs and the positioning of the discs on this chassis are different from those obtained in the case of a precision disc harrow. There is no opening angle for the disc. Moreover, generally the discs are provided with a central recess permitting threading each disc on a support beam of the chassis. In the installed condition on the support beam of the chassis, these discs do not comprise, in the position of smallest encumbrement as to the length of the chassis which is generally a chassis with beams disposed in an X, an opening angle. Because of this, when an angle of opening of about 20° must be imposed on the disc, each support beam of the chassis, which is mounted pivotably about a vertical axis, is moved angularly by a value of about 20° to obtain the value of the angle of opening selected for each disc. There results a very large size as to length of such a chassis. Moreover, in the case of such a machine, the removal of each disc is not provided.

An object of the present invention is thus to provide a groundworking machine of the disc harrow type whose design permits the discs, mounted independently and oscillating on the support chassis, to be orientable to have an adjustable angle opening without substantially increasing the size in length of the assembly of the machine and without complicating the disc-support connection.

To this end, the invention has for its object a soil working machine, of the precision disc harrow type, comprising a chassis, carried or dragged, provided with plowing tools comprised by at least one forward series and one rearward series of non-driven rotatable discs, each disc or group of discs of a series of discs, being, so as to obtain working of the soil at constant depth of the discs,, coupled, independently, by means of a safety device, to a support, such as a beam, common to the assembly of the discs of the series of discs, each safety device permitting removal, by lateral and/or vertical escape, of the corresponding disc or group of discs, beyond a predetermined pressure exerted on the disc or group of discs, characterized in that each disc or group of discs of a series of discs is, in the condition coupled to its support common to the assembly of discs of the series of discs, driven to rotate about an axis which forms with the longitudinal axis of the support an angle a at least equal to 2°, preferably comprised within the range 3°-40°, particularly to confer by construction on the assembly of discs of the series of discs a value β1 of the opening angle considered as optimum in a position corresponding to a position of smallest size in length of the supports, each support common to the assembly of discs of a series of discs being mounted on the chassis, pivotably about a vertical axis so as to permit adjustment of the value of the opening angle of the assembly of the discs of the series of discs within a predetermined angular range without substantially increasing the size as to length of the assembly of the machine and without complicating the disc-support connection.

Thanks to the fact that the discs of the series of discs are mounted on their support with the first fixed predetermined opening angle adjacent an optimum value in the position of least encumberment as to length of the support, the movement of the support by driving with pivoting about a vertical axis, can take place within a reduced angular range because this movement is necessary only to permit optimizing and adjusting in the finest way the value of the opening angle as a function of the nature of the ground or of the type of work to be carried out. As it is a matter only of an adjustment of the value of the opening angle of each disc about its optimum value predetermined by construction, the angular movement of the support takes place only over several degrees and the increase of size as to length of the support which results is extremely small. Moreover, the fact of acting on the movement of the support common to the disc of a series of discs and not on the connection between the discs and support to permit the adjustment of the opening angle, permits on the one hand not having to complicate this connection between disc and support, and on the other hand to carry out such an adjustment in a short time.

The invention will be fully understood from the reading of the following description of examples of embodiment, with reference to the accompanying drawings, in which:

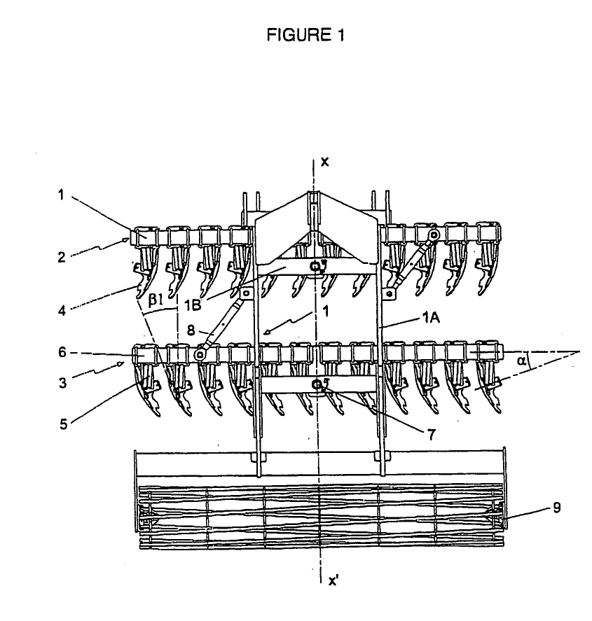

FIG. 1 is a top plan view of a machine for working the soil according to the invention in the position of least encumberment of the supports of discs of the chassis;

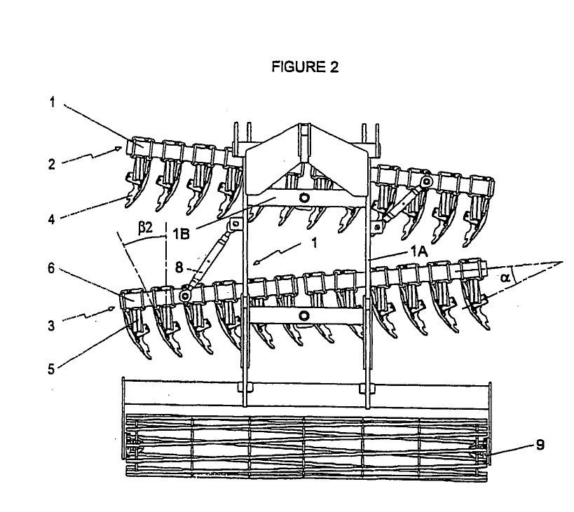

FIG. 2 shows a top plan view of a working machine of the ground according to the invention, in a position in which the opening angle of the discs is different from that shown in FIG. 1; and

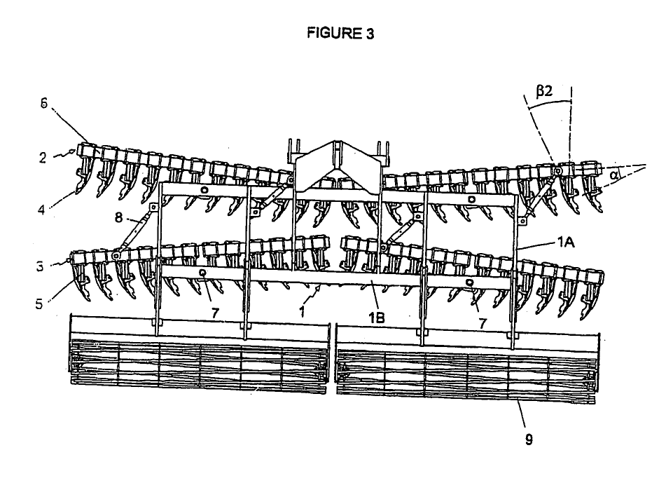

FIG. 3 is a top plan view of a working machine of the soil according to the invention in which the embodiment of the chassis and of the disc supports have been modified.

As mentioned above, the soil working machine of the precision disc harrow type, according to the invention, comprises a chassis 1, carried or dragged, provided with plowing tools. The chassis 1 can have a large number of forms. In the illustrated examples, this chassis 1 is constituted by at least one frame formed of two bars 1A interconnected by crosspieces 1B extending substantially perpendicularly to the line of advancement XX′ of the machine. The chassis 1 is moreover provided with a device for attachment to a traction vehicle (not shown). The connection will preferably be of the three point type. The plowing tools are themselves constituted by at least one front series 2 and one rear series 3 of non-driven rotatable discs 4. These front and rear series of discs each extend along a working width which is to say along a line perpendicular to the line XX′ of advance or traction of the chassis 1. It is to be noted that, by non-driven disc harrow, there is meant harrowing discs whose drive in rotation takes place under the influence of frictional force with the ground, which force is generated by movement of the chassis.

In the illustrated examples, these discs 4 work in the ground according to an adjustable depth by means of at least one reference member 9, preferably rotatable, such as a wheel or roller, coupled to the chassis 1 of the machine. This reference member 9, common to the assembly of the discs 4 of the machine is positioned, preferably behind the last series of discs 4, taking in the direction of advance of the machine.

In the illustrated examples, the member 9 for adjustment of penetration is constituted by a roller common to the assembly of the disc harrow discs of the rear series of the disc harrow. This roller is coupled to the chassis 1 by means of two arms extending rearwardly of the plane forming the chassis, said arms being adjustable in position along the chassis 1. This adjustment of depth takes place by coaction of disc reference member with the coupling device.

The plowing tools, constituted by the non-driven rotatable harrow discs 4, are made such that each disc or groups of discs of a series 2, 3 of discs is mounted independently and oscillably relative to the chassis 1 that carries the disc harrow, so as to retract under a predetermined adjustable pressure thereby to obtain working of the ground at constant depth by the harrow discs 4. Each disc 4 is thus connected to the chassis 1 by a safety device 5 permitting withdrawal by lateral and/or vertical escape of the corresponding disc 4 or group of discs 4 when the pressure exerted on the disc or group of discs is greater than a predetermined value. In the illustrated examples, each disc 4 or group of discs 4 of a series of discs is thus connected to the support common to the assembly of the discs of a series of discs, by a safety device 5 constituted by at least one helicoidal spring forming at least one spiral, preferably at least one spiral and a half, so as to create, in the spring, a region of overlapping or duplication during contraction of the turns. One end of the spring is directly connectable or by means of a connection piece, to the chassis, whilst the other end of the spring is coupleable, on the concave side of the disc, to the hub of the disc. This spring is oriented such that the turn or turns of the spring tighten by winding up when the pressure exerted on the disc is greater than the predetermined pressure by permitting vertical removal of the disc by rising or a lateral escape of the disc.

Clearly, other embodiments of such a safety device can be envisaged such as a spring-loaded pivoting arm.

In a manner characteristic of the invention, each disc 4 or groups of discs 4 of a series of discs is, in the condition coupled to its support 6, common to the assembly of the discs of the series 2,3 of discs 4, driven in rotation about an axis which forms with the longitudinal axis of the support 6 an angle a comprised within the range 3°-40°, preferably comprised within the range 6°-35°, still more preferably adjacent 20°. This particular arrangement of the disc relative to the support beam 6 thereby permits conferring on the assembly of the discs of the series of discs a value β1 of the opening angle judged to be optimum by the builder in a position corresponding to a position of least size and length of the support 6. This value β1 has the same values as α. This position of least encumberment as to length, which is particularly shown in FIG. 1, corresponds to a position in which the supports are each made in the form of a beam, said beams extending parallel to each other and perpendicular to the axis XX′ of advancement of the chassis.

When the nature of the ground requires a different adjustment of the opening angle of each disc relative to the predetermined fixed value corresponding to the angle Pi in the position of least size of the chassis, the operator can adjust this value of the opening angle. To this end, each support 6 common to the assembly of the discs 4 of a series 2, 3 of discs 4 is mounted on the chassis 1, for pivoting about a vertical axis so as to permit by pivoting drive of said support 6 about its vertical axis, an adjustment of the value of the opening angle of the assembly of discs 4 of the series 2, 3 of discs 4 about the predetermined value β1. This adjustment thus takes place within a predetermined angular range without increasing substantially the size and length of the assembly of the machine and without complicating the disc 4—support 6 connection. Thus, as the value β1 of the opening angle in the position of least size of the chassis corresponds to an optimum value of near the optimum value, the angle and movement of the support 6 necessary to optimize this value when the nature of the ground changes, corresponds to a rotation of several degrees of the support beam 6 about the pivot connection 7 of the support beam 6 on the chassis 1 (see the double arrow in FIG. 1). Because of this, the increase in size lengthwise of the machine which results from this debiting drive is extremely small. If the disc did not have at the outset an opening angle β′ near the value considered as optimum by the builder, it would be necessary to drive pivotably the disc support common to the discs of a series of discs within a wide range to permit obtaining an optimum value of the opening angle.

Thanks to pre-mounting of the disc on its support, each support 6, common to the assembly of discs 4 of a series 2, 3 of discs 4, is thus movable angularly within an angular range equal at least to 2°, preferably comprised between 6 and 25°. It thus suffices for example to be able to drive angularly, about the connection pivot 7, the support 6 common to the discs of a series of discs by a value of 10° in one direction or the other relative to the position of least size as to length, which corresponds to an angular range of 20° to be able to cover the assembly of the optimum values of the opening angle no matter what the nature of the ground and the type of work to be carried out. As a result, in each end position taken by the supports of the chassis, there is a small increase in the size as to the length of the chassis of the machine.

In the illustrated examples each support 6, common to the assembly of the discs 4 of a train 2, 3 of discs 4 and coupled to the chassis 1 by a pivotal connection 7 with a vertical axis, is driven pivotably about said vertical axis by means of a control member 8, such as a jack, preferably controlled as to operation from a tractive vehicle of the machine.

Several embodiments of the machine can be envisaged. Thus, in the examples shown in FIGS. 1 and 2, the machine for working the soil comprises two supports 6 of the beam type extending substantially parallel to each other and orthogonally to the axis XX′ of advance of the chassis in a position of so-called least size as to length. These two supports 6 of the beam type are positioned respectively one before the chassis 1, the other to the rear of the chassis 1, and each extends over a working width of the machine. Each beam 6 is coupled by a pivotal connection 7 to a crossmember 1B of the chassis 1, this crossmember 1B extending itself between two bars 1A of the chassis 1. Each support 6 is driven pivotally about the pivotal connection 7 by means of a jack 8 extending between beam and bar 1A of the chassis. This pivoting drive is controlled in a manner such that the support beams 6 thus form a V between themselves beyond their position of smallest size as to length. The pivotal connection 7 is preferably disposed each time in the substantially median region of the support 6 common to the discs of a series of discs. Thus, in the position of least size as to length of the supports 6, as shown in FIG. 1, the support beams 6 extend parallel to each other, each disc having in this position of the support beams 6 an opening angle β1 comprised within the range 3°-40°, preferably comprised between 6°-35°, and more preferably adjacent 20°. In FIG. 2, the opening angle has been adjusted to a value β2 near 24°, greater than the β1 value near 20° of the opening angle selected by the builder. To this end, each support has been driven in rotation. Thus, during adjustment of the opening angle, which corresponds to the angle formed by the plane of rotation of the disc with a vertical plane parallel to the axis XX′ of advance, the supports 6 are driven pivotably in two opposite directions. The forward support is thus driven in FIG. 2 pivotably toward the right whilst the rear support is driven pivotably toward the left such that the supports form a V between them.

In the example shown in FIG. 3, the machine for working the soil comprises four supports 6 of the beam type formed by two supports positioned before the machine and two supports positioned behind the machine. Each support is common to an assembly of discs or group of discs of a series of discs. These supports 6 thus cover pairwise a working width of the machine. Each support 6 is coupled to the chassis 1 by a pivot connection 7 with a vertical axis extending substantially in the median portion of said support 6. The supports 6 thus arranged form when seen from above an X or lozenge beyond their position of least size as to length in which the two supports positioned in front of the chassis are disposed aligned and extend orthogonally to the axis XX′ of advance of the chassis, as also the two supports positioned behind the chassis, the supports being moreover parallel to each other.

In the illustrated embodiments, the discs are concave discs of large diameter, preferably crenelated and have reverse concavity from one series of discs to another on the one hand between series of discs positioned substantially along a same working width of the machine, on the other hand between series of discs axially offset relative to the longitudinal axis of the machine. Thus, the discs of the two front series of discs have a concavity reversed from a series of discs to another. Each forward series of discs has moreover discs with opposite concavity to the discs of the rear series of discs which it precedes. Thus, one of the branches of the X, as shown in FIG. 3, is constituted by two supports 6 with discs having a same orientation of the concavity, whilst the other branch of the X is constituted by two supports whose discs generally have a same concavity reversed relative to the discs of the first leg of the X.

In the example shown in FIGS. 1 and 2, in which the chassis is provided only with two supports in the form of a beam, each support being common to the discs of a series of discs, again each disc 4 of a train 2, 3 of discs being a concave disc of large dimension, preferably at least equal to 40 cm. The discs thus have a reverse concavity from one series 2 of discs to another series 3 of discs when the series 2 of is offset axially relative to the longitudinal axis of the machine. Thus, the forward series of discs has discs with a concavity reversed relative to the discs of the rear train of discs.

To perfect the operation of the assembly, each disc 4 or groups of discs 4 moreover has a camber angle comprised within the range 3°-20°. This camber angle is fixed by construction at the time of assembly of the disc on the support 6 common to the assembly of discs of the series of discs. The role of this camber angle will not be described in greater detail here.

As shown in the figures and in particular the passage of FIG. 1 to FIG. 2, it thus becomes very easy to adjust the value of the opening angle. It suffices for this purpose to drive pivotably each support 6 common to the discs of a series of discs by several degrees as a function of the optimum value of the angle selected by the operator according to the nature of the soil or the desired working depth or of the amount of penetration into the soil that is desired.

1. Machine for working the soil, of the precision disc harrow type, comprising a chassis (1) , carried or dragged, provided with plowing tools formed by at least one front series (2) and rear series (3) of non-driven rotatable discs (4), each disc (4) of the group of discs of a series (2, 3) of discs, being, so as to obtain working of the soil at a constant depth by the discs (4), coupled, independently, by means of a safety device (5), to a support (6), such as a beam, common to the assembly of the discs (4) of the series (2, 3) of discs (4), each safety device (5) permitting the removal, by lateral and/or vertical escape, of the corresponding disc (4) or group of discs (4), beyond a predetermined pressure exerted on the disc or group of discs,
characterized in that each disc (4) or group of discs (4) of a series of discs is, in the condition coupled to its support (6), common to the assembly of the discs of the series (2, 3) of discs (4), driven in rotation about an axis which forms with the longitudinal axis of the support an angle a at least equal to 20, preferably comprised within the range 3°-40°, particularly to confer by construction on the assembly of the discs of the series (2, 3) of discs (4) a value β1 of the opening angle considered as optimum in a position corresponding to a position of least size as to length of the supports (6), each support (6), common to the assembly of the discs (4) of a series (2, 3) of discs (4), being mounted on the chassis (1), to pivot about a vertical axis so as to permit an adjustment of the value of the opening angle of the assembly of discs (4)of the series (2, 3) of discs (4) within a predetermined angular range without increase substantially the size as to length of the assembly of the machine and without complicating the disc (4)—support (6) connection.

2. Soil working machine according to claim 1,
characterized in that each support (6), common to the assembly of the discs of a series (2, 3) of discs (4), is movable angularly within an angular range at least equal to 2°, preferably comprised between 6 and 25°.

3. Machine for working the soil according to claim 1,
characterized in that the angle α, formed by the axis of rotation of each disc (4) of a series (2, 3) of discs (4) with the longitudinal axis of the support (6) of the series (2, 3) of discs (4), and comprised within the range 3°-4°, is selected to be about 20°.

4. Machine for working the soil according to claim 1,
characterized in that support (6), common to the assembly of the discs (4) of a series (2, 3) of discs (4), and coupled to the chassis (1) by a pivot connection (7) with a vertical axis, is driven pivotably about said vertical axis by means of a control member (8), such as a jack, preferably controlled as to function from a tractive vehicle of the machine.

5. Machine for working the soil according to claim 1,
characterized in that it comprises two supports (6) of the beam type, positioned respectively one in front of the chassis (1), the other behind the chassis (1), and each extending over a working width of the machine, each beam (6) being coupled by a pivotable connection (7) to a crosspiece (1B) of the chassis (1), this crosspiece (1B) itself extending between two longitudinal bars (1A) of the chassis (1).

6. Machine for working the soil according to claim 1,
characterized in that it comprises four supports (6) of the beam type formed by two supports positioned in front of the machine and two supports positioned behind the machine, these supports (6) covering pairwise a working width of the machine, each support being coupled to the chassis (1) by a pivotal connection (7) with a vertical axis extended substantially in the medial portion of said support (6).

7. Machine for working the soil according to claim 1,
characterized in that each disc (2) of a series (2, 3) of discs is a concave disc of a large diameter, the discs having a reverse concavity from one series (2) of discs to another series (3) of discs on the one hand between series of discs positioned substantially on a same working width of the machine, on the other hand between series of discs axially offset relative to the longitudinal axis of the machine.

8. Machine for working the ground according to,
characterized in that each disc (4) or group of discs (4) moreover has a camber angle comprised in the range 3 to 20°.

9. Machine for working the soil according to claim 1,
characterized in that the chassis (1) is provided with a reference member (9) preferably rotatable, such as a wheel, a roller, common to the assembly of the discs of the machine, this reference member (9) being positioned preferably behind the last series of discs (4) taken in the direction of advance of the machine, this reference member ensuring adjustment of the depth of the discs (4) working in the soil.

10. Machine for working the soil according to claim 1,
characterized in that each disc (4) or group of discs (4) of a series (2, 3) of discs (4) is connected to the support (6) common to the assembly of the discs of the series (2, 3) of discs (4) by a safety device (5) constituted by at least one helicoidal spring forming at least one winding, preferably at least one and .a half windings, so as to create, at the level of the spring, a region of overlap, one end of the spring being coupleable directly or by means of a connection member to the chassis whilst the other end of the spring is coupleable to the hub of the disc, the spring being oriented such that the winding or windings of the spring tighten by winding up when the pressure exerted on the disc is greater than the predetermined position pressure to permit a vertical removal of the disc by raising or a lateral escape of the disc.
